(19) United States
(12) Patent Application Publication
(10) Pub. No.: US 2009/0013218 A1
(43) Pub. Date: Jan. 8, 2009

(54) DATALOG MANAGEMENT IN SEMICONDUCTOR TESTING

(75) Inventors: Eran ROUSSEAU, Rehovot (IL); Igal GURVITS, Mazkeret Batya (IL); Reed LINDE, El Dorado Hills, CA (US); Gil BALOG, Jerusalem (IL)

Correspondence Address: BROWDY AND NEIMARK, P.L.L.C.;624 NINTH STREET, NW, SUITE 300, WASHINGTON, DC, 20001-5303, US

(73) Assignee: Optimal Test Ltd., Nes-Zionna (IL)

(21) Appl. No.: 11/772,676

(22) Filed: Jul. 2, 2007

(51) Int. Cl. G06F 11/07

(52) U.S. Cl. 714/48; 714/E11.147

(57) ABSTRACT

Methods, systems and modules for datalog management. In one embodiment, the logging of data is allowed to at least occasionally occur while the handling equipment is preparing device(s) for testing. Additionally or alternatively, in one embodiment with a plurality of test site controllers, after testing has been completed at all test site(s) associated with a particular test site controller the logging of data relating to that test site controller is allowed to at least occasionally occur while testing is continuing at test site(s) associated with other test site controller(s).

### FIELD OF THE INVENTION

This invention relates to semiconductor device testing and more specifically to the logging of test data (“data-logging”).

### BACKGROUND OF THE INVENTION

The logging of test data (including inter-alia test results), which is created during execution of test programs on semiconductor devices, increases the time required for testing. Test capacity is an inverse function of test time, since test capacity is the volume of material (i.e. number of semiconductor devices) that can be processed through a factory test operation within a fixed period of time, given the available test equipment and test times for that operation. The desire to increase capacity may therefore provide motivation to reduce the amount of test data collected through data-logging. On the other hand, since data logged during testing is critical to the kind of analysis involved in many semiconductor manufacturing improvement activities, including test time reduction, yield improvement, quality and reliability improvement, design improvements, etc., there is motivation to maintain data-logging, and in some cases even to increase data-logging. As a result of these conflicting motivations, trade-offs during high volume testing are being made in practice. For example, in some cases, datalog is sampled on only part of the material tested (i.e. test data relating to some material is logged, while test data relating to other material is not logged).

Typically, although not necessarily, the difference between a test on which data is logged (i.e. a test which is data-logged) and a test that is not data-logged is in the level of detail of information produced in test output. A test that is not data-logged may in some cases produce no output at all, or may in some cases simply produce a failure indicator in the event of test failure. A test that is data-logged, on the other hand, may in some cases produce detailed information about the test results, often even when the device has passed all test conditions. For example, in the absence of datalog the output of a test of a device's power consumption might simply be a pass/fail indicator of whether or not its power use exceeds specifications. However, if the test is data-logged, a measurement of the actual power level consumed by the device is made and recorded in this example. In another example, a test may be developed to determine the maximum or the minimum power supply voltages under which a device remains functional, and the resulting power supply voltage values obtained in this test may be data-logged. Broadening this second example, a device may be tested through a sequence of various test conditions, and rather than simply terminating with a pass/fail indicator of the device's compliance to the set of test conditions, the identity of any specific conditions under which the device failed to operate correctly might be data-logged.

### SUMMARY OF THE INVENTION

According to the present invention, there is provided a system for managing logging of semiconductor test data, comprising: handling equipment configured to prepare a semiconductor device for testing; a datalog generation tool configured to log data relating to semiconductor testing; and a datalog manager configured to at least occasionally allow the datalog generation tool to log data while the handling equipment is preparing the device for testing.

According to the present invention, there is also provided a module for managing datalog, comprising: at least one interface configured to at least receive a first indication that a device is being prepared for testing and a second indication that the device is ready for testing; and a datalog manager control engine configured to schedule logging of data based at least partly on any received first and second indications.

According to the present invention, there is further provided a method of managing logging of semiconductor test data, comprising: allowing logging of semiconductor test data during at least part of a time interval in which a group of at least one device is being prepared for testing by handling equipment.

According to the present invention, there is provided a system for managing logging of semiconductor test data, comprising: a tester operating system and test program server associated with a test site controller configured to test at least one device, the at least one device being tested in parallel with at least one other device; a datalog generation tool configured to log data relating to semiconductor testing; and a datalog manager configured to at least occasionally allow the datalog generation tool to log data relating to the test site controller after the at least one device has completed testing but testing is continuing at any of the at least one other device.

According to the present invention, there is also provided a method of managing logging of semiconductor test data, comprising: testing devices in parallel at test sites associated with test site controllers; and allowing logging of semiconductor test data relating to one of the test site controllers during at least part of a time gap between testing completion at all test sites associated with the one test site controller and testing completion at all test sites associated with the test site controllers.

According to the present invention, there is further provided a module for managing datalog, comprising: at least one interface configured to at least receive an indication that testing has completed at all test sites associated with a test site controller; and a datalog manager control engine configured to at least occasionally allow logging of data relating to the test site controller after the indication has been received while testing is continuing at at least one other test site associated with a different test site controller.

According to the present invention, there is provided a computer program product comprising a computer useable medium having computer readable program code embodied therein for managing logging of semiconductor test data, the computer program product comprising: computer readable program code for causing the computer to allow logging of semiconductor test data during at least part of a time interval in which a group of at least one device is being prepared for testing by handling equipment.

According to the present invention, there is still further provided a computer program product comprising a computer useable medium having computer readable program code embodied therein for managing logging of semiconductor test data, the computer program product comprising: computer readable program code for causing the computer to test devices in parallel at test sites associated with test site controllers; and computer readable program code for causing the computer to allow logging of semiconductor test data relating to one of the test site controllers during at least part of a time gap between testing completion at all test sites associated with the one test site controller and testing completion at all test sites associated with the test site controllers.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a block diagram of a system for testing semiconductor devices and logging test data, according to an embodiment of the present invention;

FIG. 2 is a conceptual illustration showing the indexing of packaged devices into a test socket on a loadboard at a final test operation, according to an embodiment of the present invention;

FIG. 3 is a sample of ASCII data relating to the testing of semiconductor devices, according to an embodiment of the present invention;

FIG. 4 is a block diagram of a datalog manager, according to an embodiment of the present invention;

FIG. 5 (comprising FIG. 5A and FIG. 5B) is flowchart of a method of managing data-logging, according to an embodiment of the present invention;

FIG. 6 is a flowchart of another method of managing data-logging, according to an embodiment of the present invention; and

FIG. 7 (comprising FIG. 7A and FIG. 7B) is a flowchart of another method of managing data-logging, according to an embodiment of the present invention.

### DETAILED DESCRIPTION OF EMBODIMENTS

Described herein are embodiments of the current invention for datalog management.

Some embodiments described herein minimize or render negligible the amount of time that data-logging adds to the time required for processing semiconductor devices under test, thereby optimizing processing time (i.e. throughput time) and test capacity. In some of these embodiments the optimization may be achieved without requiring any significant reduction in the amount of datalog data being processed and/or any significant increase in system hardware costs (for example without requiring more computational “horse-power” obtained through hardware enhancements such as upgrading the CPU to one with higher performance, adding additional CPU's, adding more memory, etc).

As used herein, the phrase “for example,” “such as” and variants thereof refer to non-limiting embodiment(s) of the present invention.

Unless defined otherwise, all technical and scientific terms used herein have the same meaning as commonly understood by one of ordinary skill in the art to which this invention belongs. Generally (although not necessarily), the nomenclature used herein described below are well known and commonly employed in the art. Unless described otherwise, conventional methods are used, such as those provided in the art and various general references.

Reference in the specification to “one embodiment”, “an embodiment”, “some embodiments”, “another embodiment”, “other embodiments” or variations thereof means that a particular feature, structure or characteristic described in connection with the embodiment(s) is included in at least one embodiment of the invention. Thus the appearance of the phrase “one embodiment”, “an embodiment”, “some embodiments”, “another embodiment”, “other embodiments”, or variations thereof do not necessarily refer to the same embodiment(s).

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Some embodiments are primarily disclosed as a method and it will be understood by a person of ordinary skill in the art that an apparatus such as a conventional data processor incorporated with a database, software and other appropriate components may be programmed or otherwise designed to facilitate the practice of these embodiments.

Unless specifically stated otherwise, as apparent from the following discussions, it is appreciated that throughout the specification discussions, utilizing terms such as, “providing”, “managing”, “realizing”, “completing”, “waiting”, “preventing”, “continuing”, beginning”, “anticipating”, “logging”, “arranging”, “checking”, “allowing”, “testing” “preparing”, “determining”, “placing”, “removing”, “loading”, “unloading”, “indexing” “receiving”, “recognizing”, “enabling”, “disabling”, “indicating”, “scheduling”, “proceeding”, or the like, refer to the action and/or processes of any combination of software, hardware and/or firmware. For example, in one embodiment a computer, processor or similar electronic computing system may manipulate and/or transform data represented as physical, such as electronic., quantities within the computing system's registers and/or memories into other data, similarly represented as physical quantities within the computing system's memories, registers or other such information storage, transmission or display devices.

Embodiments of the present invention may use terms such as, processor, device, tool, interface, computer, apparatus, memory, controller, console, system, element, sub-system, server, engine, module, manager, component, program, prober, handler, unit, equipment, etc, (in single or plural form) for performing the operations herein. These terms, as appropriate, refer to any combination of software, hardware and/or firmware configured to perform the operations as defined and explained herein. The module(s) (or counterpart terms specified above) may be specially constructed for the desired purposes, or it may comprise a general purpose computer selectively activated or reconfigured by a program stored in the computer. Such a program may be stored in a readable storage medium, such as, but not limited to, any type of disk including optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, any other type of media suitable for storing electronic instructions that are capable of being conveyed, for example via a computer system bus.

The method(s)/processe(s)/module(s) (or counterpart terms for example as specified above) presented herein are not inherently related to any particular system or other apparatus, unless specifically stated otherwise. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

Systems, methods and modules described herein are not limited to testing of particular types of semiconductor devices, and may be applied to CPU's, memory, analog, mixed-signal devices, and/or any other semiconductor devices. For example, in one embodiment testing of the semiconductor devices may occur through use of automated electronic test equipment, potentially in combination with BIST (Built-In Self-Test) circuitry. Also, there are no limitations on the type of testing to which systems, methods and modules described herein can be applied. For example, depending on the embodiment, the systems, methods and modules described herein can benefit wafer-level sort operations, strip-test operations, final test package-level test operations, multi-chip-package module-level test operations, and/or any other test operations. The term “devices” refers to semiconductor devices and may refer to the semiconductor devices at any stage of the manufacturing process (fabrication and/or testing), and is therefore not limited herein to any particular stage. For example in one embodiment, the devices are commonly called dice when in wafer form. For example, in one embodiment, the devices are commonly called packaged parts or packed devices in final test. Systems, methods and modules described herein can be applied to any semiconductor test environment depending on the embodiment, including inter-alia sequential and/or parallel (synchronous and/or asynchronous) test environments.

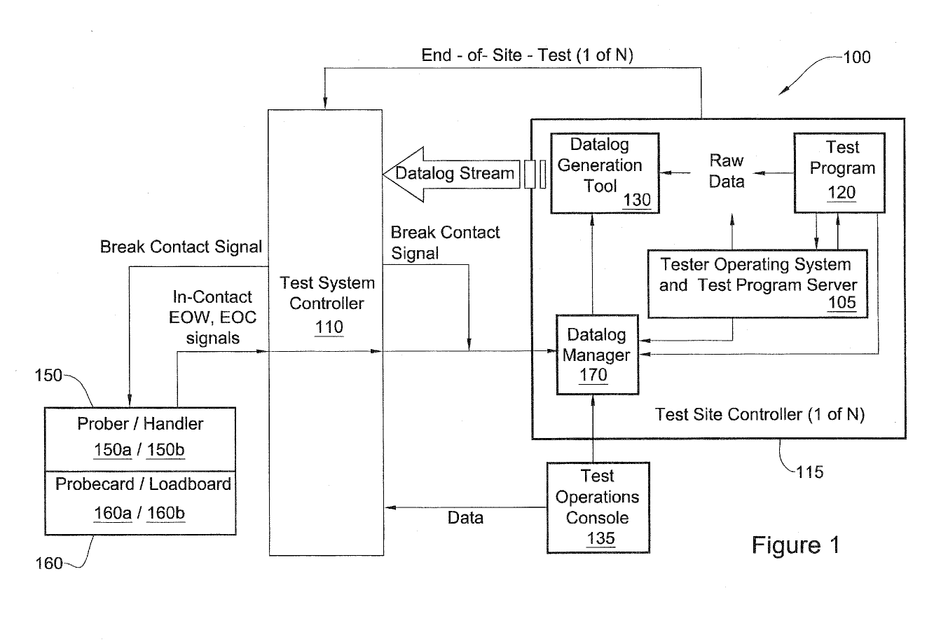

Referring now to FIG. 1, a system 100 for testing semiconductor devices and logging test data, according to an embodiment of the present invention is illustrated. Only elements pertinent to embodiments of the invention are shown, for simplicity of illustration. Each element in FIG. 1 is named in the single form for ease of description, but should be understood to include embodiments where there is a single or a plurality of that element in system 100. In the embodiment illustrated in FIG. 1, system 100 includes a test system controller 110, N test site controllers 115 (N≧1), a test operations console 135, handling equipment 150, and an interface unit 160. Each of elements 110, 115, 135, 150 and/or 160 may be made tip of any combination of software, hardware and/or firmware that performs the functions as defined and explained herein. In one embodiment, system 100 may comprise fewer, more and/or different elements than shown in FIG. 1. In one embodiment, system 100 may include additional, less and/or different functionality described herein. In one embodiment, any of elements 110, 115, 135, 150, and/or 160 may include additional, less and/or different functionality than described herein. Depending on the embodiment, elements 110, 115, 135, 150, and/or 160 may be concentrated or dispersed.

Now will be described some embodiments of handling equipment 150 and interface unit 160. As shown in FIG. 1, handling equipment 150 communicates with test system controller 110. In some embodiments., the communication between handling equipment 150 and test system controller 110 may occur, for example, via parallel digital communication, RS-232 serial communication, a Transmission Control Protocol/Internet Protocol TCP/IP network, a GPIB bus (General Purpose Interface Bus), also known as a IEEE-488 or HP-IB bus (Hewlett-Packard Instrument Bus), or by any other means of communication.

As mentioned above, in one embodiment, devices are tested a single one at a time, sequentially, whereas in another embodiment, several are tested at the same time “in parallel”. A plurality of devices being tested in parallel is sometimes referred to as a “touchdown”. The term “touchdown” is used because interface unit 160 (for example, at wafer sort—a probecard 160a, or at final test—the loadboard 160b) usually “touches” the plurality of devices under test to make electrical contact. The physical touching however is not necessary for embodiments of the invention, and in some cases instead of a physical contact there may be, for example, an electrical inductive coupling with interface unit 160. In the description herein, the terms “contact”, “contacted”, “electrical contact”, “electrical contacted” and so forth refer to an electrical pairing between device(s) under test and interface unit 160 including inter-alia: physical contact, electrical inductive coupling or any other appropriate electrical pairing.

In some embodiments, in the case of a wafer sort test operation, where wafer-level testing of devices is being performed, handling equipment 150 includes a wafer prober 150a and interface unit 160 includes probecard 160a. In one of these embodiments prober 150a includes a prober chuck which provides mechanical support and thermal stability to a wafer which sits on the chuck while being sorted. In one embodiment, at a final test operation, after the wafer has been sawed-up to separate individual devices and those devices have been placed in packages, handling equipment 150 includes a unit handler 150b and interface unit 160 includes a loadboard 160b. Whether representing a wafer-level sort test operation or a package-level final test operation, one or more devices may in one embodiment be electrically contacted with interface unit 160 during testing, allowing testing to occur either on individual devices, sequentially, or on multiple devices at a time, in parallel. In one embodiment, handling equipment 150 may represent equipment for placing devices in electrical contact with interface unit 160 for a “strip test” operation, in which devices are tested at an intermediate stage of assembly, after having sawed-up wafers to singulate and mount individual die on package leadframes, but before singulating the individual packaged units.

In some embodiments, handling equipment 150 may be any suitable commercially available prober or handler including inter-alia: Tel P8i, Tel P12×1 (both manufactured by Tokyo Electron Limited, headquartered in Tokyo, Japan), Advantest 4741, and Advantest M4841 (the latter two manufactured by Advantest Corporation, headquartered in Tokyo, Japan).

During the processing of the devices under test, there are times when handling equipment 150 is preparing a group for testing. Depending on the embodiment, the group that is being prepared may include a single device which will be tested at a time or may include a plurality of devices which will be tested in parallel. Therefore, the term “group” should be understood herein below to include one or more devices.

Preparing action(s) and time(s) associated with these action(s) are referred to herein below as “preparing”, “preparation”, or using similar terms. During preparing, actual testing (i.e. execution of test program(s)) is halted. The time for preparing therefore represents an additional overhead time which adds to the total time required to process semiconductor devices under test.

In some embodiments, handling equipment 150 may prepare a group (of one or more devices) for testing by any of the following activities, inter-alia: removing a group of previously tested devices from electrical contact with interface unit 160, unloading a batch of previously tested devices, loading a batch of untested devices which includes the group which is being prepared for testing, placing the group which is being prepared for testing in electrical contact with interface unit 160, and/or indexing. The term batch should be understood to refer to a set of devices undergoing testing together and in various embodiments may refer to a wafer, a cassette, a package holder of packaged devices, any other set of devices, or a combination of sets. For example, in some cases, handling equipment loading or unloading a batch may refer to handling equipment loading or unloading a wafer, a cassette, a package holder, etc.

In one embodiment, the physical format of a package holder depends on the type of packages used to assemble the devices. For example, for DIP (dual in-line packages), the devices from a lot are batched into “tubes” for final test; for TSOP (thin small outline packages), the devices are batched into “trays”. Another example of a package holder is the “matrix carrier”, batching BGA (“ball grid array packages”), for example, in such a way to facilitate parallel testing. The type of package holder is not limited by the examples and may comprise any suitable type. In one embodiment the handling solution depends on the nature of the package.

Depending on the embodiment, when a tested group is removed from electrical contact with interface unit 160, the next group to be placed in electrical contact with interface unit 160 may be from the same batch or from a different batch.

The term “indexing” refers to the action (and time associated with the action) in which handling equipment 150 removes a tested group from electrical contact with interface unit 160 and places another group from the same wafer or package holder in electrical contact with interface unit 160, thus preparing the other group for testing. Therefore indexing may conceptually be considered to comprise a combination of two actions, removing one group from electrical contact and placing another group into electrical contact, where the groups are from the same wafer or package holder.

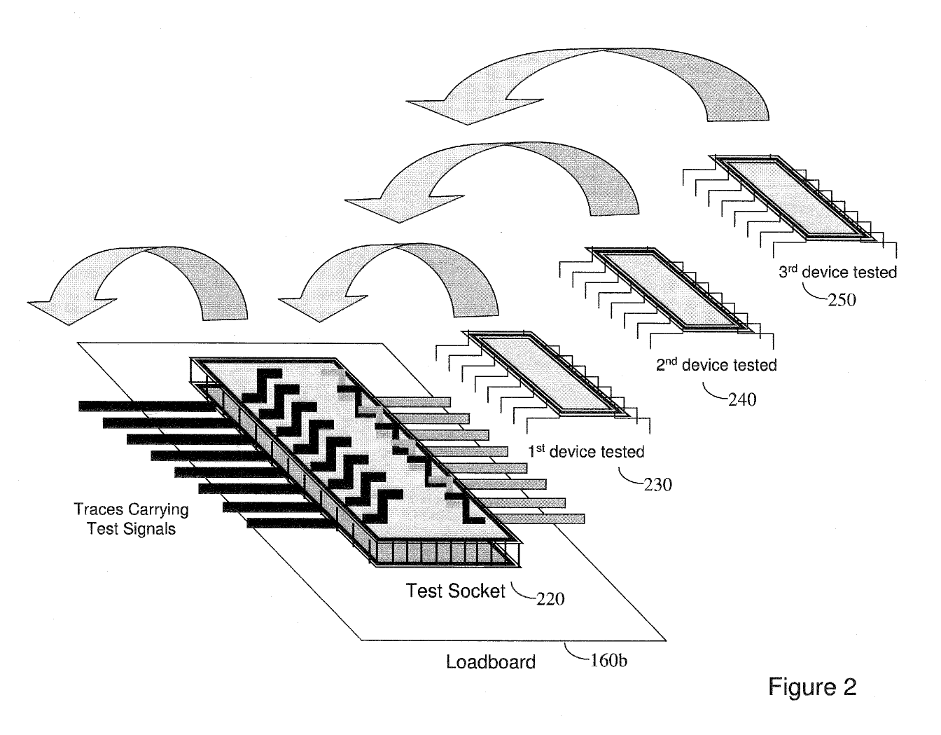

The action of indexing is illustrated, for example, for a final test environment in FIG. 2, according to an embodiment of the present invention. The conceptual illustration of FIG. 2 is not necessarily typical of a test environment. As shown in FIG. 2, a sequence of three devices—230, 240, and 250 respectively, are placed consecutively into Test Socket 220 (located on Loadboard 160b) for testing. The time required to remove the device that has just completed test and replace it with the next device requiring test is the indexing time. Typically, although not necessarily, indexing time is of fixed duration for the specific handling equipment 150 used (whether prober 150a, handler 150b, and/or other).

Another example of indexing occurs at wafer sort, in a sequential (non-parallel) test environment where devices are tested one after the other. In this example, when a device completes testing, prober 150a will move the wafer so that the next device to be tested will be contacted by probecard 160a. In another example, at wafer sort, in a parallel test environment, when devices tested together in the same touchdown have completed testing, prober 150a will move the next touchdown to be tested in place to be electrically contacted by probecard 160a. In another example, during a “strip test” operation (in which devices are tested at an intermediate stage of assembly, after having sawed-up wafers to singulate and mount individual die on package leadframes, but before singulating the individual packaged units) interface unit 160 and/or a plurality of devices mounted on a strip (a packaging leadframe or substrate) that are to be tested in parallel must be put into position for electrical contact before testing may begin.

In the above examples of indexing, the indexing time adds to the total time required to process a batch of devices under test, and therefore to the total processing time required to process a lot. It should be noted that the indexing will, by necessity, take place at a different time than the execution of the test program(s) 120 by the tester operating system and module control(s) 105 (see description below). During indexing, actual testing (i.e. execution of test program 120) is not performed, since during that time one group is being removed from electrical contact and another group is being placed into electrical contact with interface unit 160.

As mentioned above, preparing may include other times during which actual testing is necessarily halted in addition to indexing. For example, interface unit 160 may temporarily break contact with device(s) to be tested at the point in the wafer sort operation during which wafers are being exchanged (i.e., completed wafers are being unloaded from prober 150a and wafers requiring test are being loaded). As another example, interface unit 160 may temporarily break contact with devices to be tested at the point in the final test operation during which holders of packaged parts are being exchanged by handler 150b.

Therefore the reader will understand that the total time required to process devices under test is at least equal to the sum of testing times (i.e. time spent executing test program(s) 120) plus preparation times (i.e. time spent preparing devices for testing).

Referring again to FIG. 1, test system controller 110 is the overall controller of the testing, including inter-alia the coordination of testing by N (N≧1) test site controllers 115 (of which one is illustrated in FIG. 1). For example, in one embodiment, test system controller 110 coordinates communications among test site controllers 115 (assuming more than one). As another example, in one embodiment test system controller 110 alternatively or additionally coordinates communication between test site controller(s) 115 and handling equipment 150. Continuing with the example, in another embodiment, there may be direct communication between each test site controller 115 and handling equipment 150. In some embodiments with a plurality of test site controllers 115, test system controller 110 alternatively or additionally supports operations relating to more than one test site controller 115, for example relating to all test site controllers 115 in one of these embodiments.

In some embodiments, test operations console 135 is manned by test engineers and/or test operation technicians, allowing manual control of the processing of the devices under test. For example, in one embodiment, test operations console 135 is the interface by which test engineers or test operation technicians may manually enable or disable datalog relating to any of the test site(s), as desired.

In some embodiments, test system controller 110, test operations console 135 and the N test site controller(s) 115 are included in an integrated architecture. In some of these embodiments test system controller 110, test operations console 135 and/or test site controller(s) 115 communicate with one another via interfaces customized for the integrated architecture. In other embodiments, test system controller 110, test operations console 135 and the N test site controller(s) 115 are not necessarily all included in an integrated architecture and may communicate via any appropriate means of communication.

In some embodiments, test site controller 115 refers to control resources dedicated to one or more devices under test, at one or more test sites. A single test site may refer to one out of a plurality of test sites in a parallel test environment or may refer to the one test site in a sequential test environment. For each test site in one of these embodiments, handling equipment 150 provides for example a set of probes located on probecard 160a or a socket located on loadboard 160b. In one of these embodiments where N>1 each of the N test site controllers 115 operates independently of one another.

In the embodiment shown in FIG. 1 test site controller 115 includes a tester operating system and test program server 105, a test program 120, a datalog manager 170, and a datalog generation tool 130. Each of elements 105, 120, 130 and/or 170 may be made up of any combination of software, hardware and/or firmware that performs the functions as described and explained herein. In one embodiment, test site controller 115 may include fewer, more and/or different elements than shown in FIG. 1. In one embodiment, the functionality of test site controller 115 may be divided differently among elements 105, 120, 130 and 170. In one embodiment, test site controller 115 may include additional, less, and/or different functionality than described herein. In one embodiment, any of elements 105, 120, 130 and/or 170 may have additional, less, and/or different functionality than described herein.

In some embodiments referring to FIG. 1, a test execution run for one or more test sites controlled by test site controller 115 (including inter-alia execution of test program 120 by the tester operating system and test program server 105 included in test site controller 115) includes one or more individually executed tasks forming a sequence of test execution events. In some of these embodiments, during a test execution run, (raw) data is generated by test program 120 via an event-based mechanism. Alternatively or additionally in one of these embodiments, test-related (raw) data may be generated by tester operating system and test program server 105 outside of test program 120 execution via an event based mechanism. For example, tester operating system and test program server 105 may produce a stream of identifying raw data, such as test site identity, device identity, test execution time/duration, test program name and so forth. Then during test program 120 execution, elements of the individual tests in test program 120 may produce additional (raw) data in this example. Each piece of raw data is associated with a test event in one embodiment. The associated event may be for example an operation (a subroutine, a module) within one of the tests within test program 120, or for example an operation external to test program 120, such as reading a system clock or reading data previously stored from a data-entry operation, etc.

For example, in some embodiments where there are at least two devices (in at least two test sites) controlled by a particular test site controller 115, those devices may be individually selected or deselected during testing. Continuing with the example, tester operating system and test program server 105 (included in particular test site controller 115) generates signal sequences that simultaneously control the test sites of all selected devices associated with the particular test site controller 115. In these embodiments, testing between selected devices is therefore synchronized. In some of these embodiments, if device-specific test conditions are to be performed, all devices but one are deselected and the one remaining selected device is tested. In one of these embodiments, raw data is generated for each device associated with the particular test site controller 115 separately, for example sequentially for each device.

The generated raw data relating to test site controller 115 (regardless of the number of device(s)/test site(s) associated with test site controller 115) is available for datalog generation tool 130 associated with test site controller 115). In some embodiments, datalog generation tool 130 supports “pause and resume functions”, and therefore datalog by datalog generation tool 130 relating to a test site may be managed, for example allowed or disallowed by a datalog manager 170 associated with the test site (see below). In one of these embodiments, datalog generation tool 170 is customized for test site controller 115 or test system controller 110.

In one embodiment, the raw data generated by tester operating system and test program server 105 and/or by test program 120 of test site controller 115, is temporarily stored in native format in local memory at test site controller 115 prior to being retrieved by the associated datalog generation tool 130 when allowed by the associated datalog manager 170 (as described further below).

In some embodiments, among the functions of datalog generation tool 130 is the creation of the sequential stream of datalog data from the raw data. For example, in some of these embodiments, datalog generation tool 130 collects/retrieves raw data, reformats the data into a predetermined data output format, and creates a datalog data stream in event order. Continuing with the example, in one of these embodiments, based on the available information for a test site, such as whether datalog is allowed/not allowed (discussed below), which raw data are available, what type of information the raw data represent, and the order in which the events that generated the raw data occurred, datalog generation tool 130 manages the task of collecting/retrieving, sequencing, and formatting the raw data relating to test-site(s) controlled by associated test site controller(s) 115.

In one embodiment, the datalog stream holds the event records in the order in which the events occurred. In this embodiment, each event record contains all the attributes which are related to the event. As shown in FIG. 1, the datalog stream produced by each datalog generation tool 130 is transferred to test system controller 110.

In some embodiments, test operations console 135 transfers data which are not derived from the actual testing to test system controller 110. Depending on the embodiment, data transferred by test operations console 135 may include data manually entered into test operations console 135 (for example in one embodiment, any of the following inter-alia, wafer numbers, fabrication process origin, fabrication plant origin, handling equipment identity, interface unit identity, test module identity, etc), and/or data automatically generated which associates the lot number with various lot specific information (for example in one embodiment any of the following, inter-alia: wafer numbers, fabrication process origin, fabrication plant origin, etc.).

In some embodiments, test system controller 110 receives datalog stream(s) from the datalog generation tool(s) 130 associated with the N test site controller(s) 115 and receives data from test operations console 135. In these embodiments test system controller 110 combines and stores the received datalog stream(s) and data from test operations console 135. For example, in some of these embodiments storage may be provided in a non volatile memory such as a hard disk attached to test system controller 110 or a hard disk connected via a communication network.

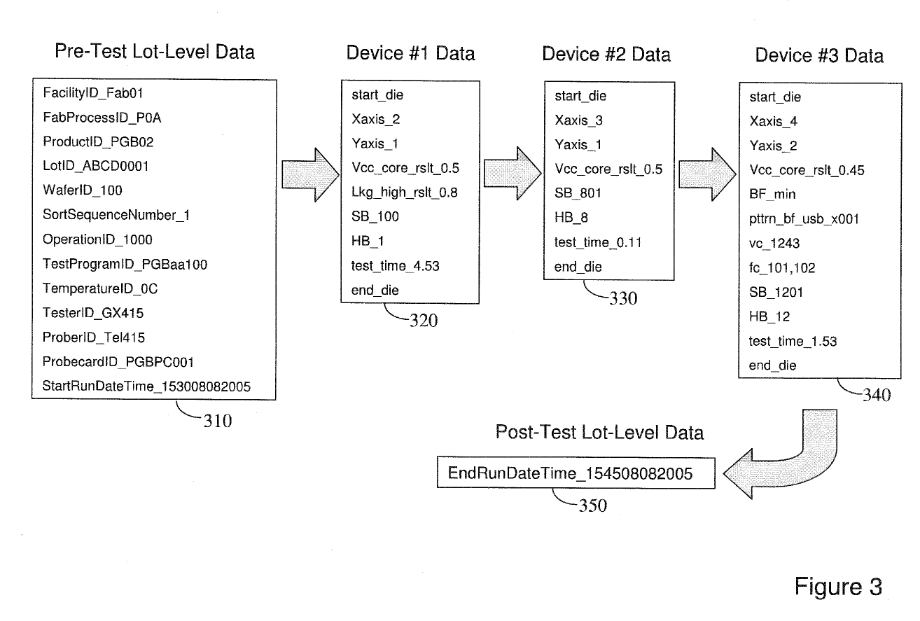

The format and content of the datalog data stream generated by any datalog generation tool 130 may vary between different semiconductor devices tested, being a function, for example, of a test site controller's specific test program 120 the configuration of tester operating system and test program server 105, and/or the functions or settings supported by datalog generation tool 130 used to generate the datalog stream, etc. There are various types of datalog formats currently used in creating a datalog stream. For example, some are binary, while others are ASCII (see below the example of FIG. 3). Currently, the binary Formats known as STDF (Standard Test Datalog Format) and ATDF (ASCII Test Datalog Format) are in wide use by semiconductor companies. Datalogs of various formats, both standardized and custom, may be created by any datalog generation tool 130, depending on the embodiment. Embodiments of the present invention, described herein, are not limited to any particular datalog format.

Refer now to FIG. 3, which shows an abbreviated example of data relating to testing which is received by test system controller 110, according to an embodiment of the present invention. In the illustrated embodiment the received data include datalog stream(s) generated by one or more datalog generation tool(s) 130 from a sort test operation for three devices and lot-level data provided by test operations console 135. It should be understood that the illustrated received data are not necessarily typical in either format or content. In this particular case, the received data shown in FIG. 3 are in ASCII format for the purposes of readability. Pre-Test Lot-Level Data 310 shown here includes fabrication plant identity “Fab01”, fabrication process identity “P0A”, lot identity “ABCD0001” wafer identity “100”, sort sequence/step identity “1”, manufacturing operation identity “1000”, test program identity “PGBaa100”, test step temperature “0C”, tester hardware identity “GX415”, prober hardware identity “Tel415”, probecard hardware identity “PGBPC001”, and the time and date the test process began “53008082005” (i.e., 3:30 pm, Aug. 8, 2005). Following next are data-sets derived from the testing of three devices—320, 330, and 340 respectively. The data-set associated with each device 320,330, 340 includes delimiting text (“start_die” and “end_die) indicating where each device's data begin and end, as well as coordinates providing the location of each device within the wafer (“Xaxis” and “Yaxis” data). Data specific to each device acquired during testing are also included, involving various items such as power supply performance, leakage, test time, and pass/fail test results. Note that the set of data included for each device may vary, as illustrated by parameters shown in device 320 dataset that are not found in the dataset of device 330, and parameters shown in device 340 dataset that are not found in the dataset of devices 320 or 330. Finally, Post-Test Lot-Level Data 350 concludes the example, consisting simply of the time and date that the test process ended “154508082005” (i.e., 3:45 pm, Aug. 8, 2005).

Refer again to FIG. 1. Assuming more than one test site controller 115 (N>1) and separate test programs 120 for each test site controller 115, test programs 120 associated with different test site controllers 115 may be the same or different depending on the embodiment. Even in an embodiment where the same test program 120 is executed for a plurality of test site controllers 115, there may or may not be concurrent execution of the test program 120, depending on the embodiment. In some embodiments, a separate datalog manager 170 manages data-logging related to each test site controller 115 as illustrated in FIG. 1, allowing independent management of the data-logging. In some of these embodiments, having separate datalog managers 170 associated with each test site controller 115 acknowledges the possibility of multiple test programs 120 and/or non-concurrent execution of test programs 120 for the various test site controllers 115. In other embodiments, a single datalog manager 170 may manage data-logging for a plurality of test site controllers 115 or for all N test site controllers 115. In some embodiments the position in system 100 of a datalog manager 170 responsible for managing datalog for at least one test site controller 115 may vary depending on the embodiment, for example located within one test site controller 115 and providing datalog management for the associated test site(s), having a location relating to a plurality of test site controllers 115 and providing datalog management for the plurality of associated test sites, located on test system controller 110 and providing datalog management for all test sites, located fully or partially outside of test system controller 110 and test site controller 115, etc. In one embodiment assuming a plurality of separate datalog managers 170 each responsible for managing datalog at different test site(s), test operations console 135 may input indications independently into each of the plurality of datalog manager 170 or independently into a subset of the plurality of datalog managers 170, whereas in another embodiment, any indications from test operations console 135 are inputted into all of the plurality of datalog managers 170. Depending on the embodiment, an indication from test operations console 135 inputted into a particular datalog manager 170 may relate to all test site(s) associated with the particular datalog manager 170 or selectively relate to test site(s) associated with the particular datalog manager 170.

Similarly assuming more than one test site controller 115 (N>1), then depending on the embodiment, each datalog generation tool 130 may generate a datalog stream relating to a different test site controller 115 or one datalog generation tool 130 may generate a datalog stream relating to a plurality of test site controllers 115.

It is assumed for simplicity of description of the embodiments herein below that if there are multiple tester operating system and test program servers 105, multiple datalog managers 170 and multiple datalog generation tools 130 in system 100, each test site controller 115 is associated with one tester operating system and test program server 105, one datalog manager 170 and one datalog generation tool 130.

In some embodiments datalog manager 170 controls the associated datalog generation tool 130 so that data-logging is at least occasionally allowed while handling equipment 150 is preparing a group of one or more devices for testing. By the term “occasionally”, it should be understood that depending on the embodiment, data-logging may or may not overlap completely with all the preparation intervals occurring during the processing of devices under test. For example, in some of these embodiments, data-logging may only be allowed during certain type(s) of preparation, for example in one embodiment concurrently with indexing. Continuing with the example, in another embodiment involving wafer-level testing at wafer sort, data-logging is allowed to occur during operations in which individual wafers are being exchanged (i.e., completed wafers are being unloaded from the prober and wafers requiring test are being loaded), in addition to or instead of data-logging during indexing. Continuing with the example, in another embodiment involving unit testing at final test, data-logging is allowed additionally or alternatively during operations in which batches of packaged devices (for example package holders) are being exchanged. Continuing with the example, in another embodiment data log may also or alternatively be allowed during preparation in “strip test” operations. Continuing with the example, in another embodiment, data-logging may also or alternatively be allowed during other preparing activities. In another example, data-logging during particular preparation interval(s) or during all preparation intervals may be overridden, for example in one embodiment by a manual indication from test operations console 135. In another example, data-logging during particular preparation interval(s) or during all preparation intervals may be allowed for some of the test sites but may be disallowed for other test sites, for example due to a manual override indication. In another example, data-logging may not be allowed while preparation is taking place because there is no data to be logged.

In some embodiments the resources used by any datalog generation tool 130 are independent of the resources used by handling equipment 150. In one of these embodiments, any data-logging which is performed concurrently with preparing has little or no impact on the length of time it takes handling equipment 150 to prepare for testing, and therefore has little or no impact on the total processing time.

Recall that during the time required to prepare a group of one or more devices for testing, actual testing is halted. In some embodiments, the resources (for example processing power and/or storage) on test site controller(s) 115 which are used during the actual testing and are idle when not testing may be exploited by any data-logging which occurs separately from actual testing, thereby allowing more efficient usage of these resources and/or enabling data-logging without requiring an augmentation of the resources of test site controller(s) 115. In some of these embodiments, assuming that there is no data-logging, test site controller(s) 115 may be completely idle or partially idle when handling equipment 150 is preparing a group for testing. For example, in one of these embodiments test site controller(s) 115 may not be completely idle during preparing, for example sending the bin (test result) when the current device(s) has completed testing. However, because actual testing is not occurring, (i.e. test program(s) 120 are not being executed by tester operating system and test program server(s) 105 ) while handling equipment 150 is preparing a group for testing, in some embodiments test site controller(s) 115 has resources available which can potentially be used for data-logging.

In some embodiments with a plurality of test site controllers 115 (N>1) a particular datalog manager 170 controls the associated datalog generation tool 130 so that data-logging related to test site(s) controlled by the associated test site controller 115 is at least occasionally allowed during the “time lag” after testing has been completed at all associated test site(s) but testing is continuing at one or more test site(s) controlled by other test site controller(s) 115. In the embodiments described herein below the term “time lag” is used to connote the difference in time between completion of testing by the various test site controllers 115. By the term “occasionally”, it should be understood that depending on the embodiment, data-logging may or may not overlap completely with all time lags occurring during the processing of devices under test. For example., in one of these embodiments, data-logging related to a particular test site controller 115 which is initiated after testing completion by that test site controller 115 may be completed prior to the completion of testing for all test sites, and therefore may not overlap completely with the time lag between test completion by that test site controller 115 and test completion at all test sites. In another example, data-logging during time lags when testing particular touchdown(s) or during time lags when testing each touchdown may be overridden, for example in one embodiment by a manual indication from test operations console 135. In another example, data-logging relating to particular test site(s) during time lag(s) when testing particular touchdown(s) or during each time lag when testing each touchdown may be allowed, but data-logging relating to other test site(s) during time lag(s) when testing those particular touchdown(s) or during each time lag when testing each touchdown may be disallowed, for example in one embodiment by to a manual override indication. In another example, data-logging may not be allowed during a particular time lag because there is no data to be logged. In some embodiments where the resources for testing at different test site controllers 115 are independent of one another, there are resources available which can potentially be used for data-logging related to a particular test site controller 115 when actual testing is not occurring at associated test site(s), regardless of the testing status at other test site(s). In one of these embodiments therefore, data-logging relating to test site(s) controlled by a particular test site controller 115 which occurs during the time lag between the time that testing ends at all test site(s) associated with that particular test site controller 115 and testing ends for all the test sites, has little or no impact on the total processing time.

In some embodiments, no data-logging is allowed during actual testing. In these embodiments because concurrent data-logging is not allowed during actual testing (execution of test program 120 by tester operating system and test program server 105), there is avoided contention for CPU resources and/or for shared memory access (for example raw data memory) between the datalog and test processes. (This contention would typically, although not necessarily, lead to longer actual testing time). However, in other embodiments, data-logging may occur, at least sometimes, during actual testing. For example, in one of these other embodiments, an over-riding enable indication from test operations console 135 may allow data-logging associated with one or more test sites during actual testing. As another example, in one of these other embodiments, data-logging that began during preparing and/or during a time lag may continue during testing for remaining raw data. As another example, in one of these other embodiments, data-logging may be at least occasionally allowed at any stage of the processing, for example, during preparing, testing and/or during any time lag when waiting for testing to end at the other test site(s).

In one embodiment, a time period dedicated to data-logging may be inserted between completing actual testing of a first group and preparing a next group for testing. In this embodiment, the data-logging period adds to the total processing time. In another embodiment, preparing a next group for testing follows as soon as possible after actual testing is completed on a first group.

Depending on the embodiment, transfer between the modules shown in FIG. 1 may vary. For example, in the embodiment illustrated in FIG. 1, communication between handling equipment and test system controller 110 may include “handling status” indications which in some cases are used for managing datalog. Continuing with the example, in one embodiment handling status indications sent from handling equipment 150 to test system controller 110 may include any of the following indications inter-alia: “in-contact” indications, where an in-contact indication indicates that a group of devices has been placed in electrical contact with interface unit 160 and is ready for test, and/or “end-of-batch” indications (for example end-of-wafer” indications or “end-of-cassette” indications), where an end-of-batch indication indicates that there are no remaining untested devices in the batch. Still continuing with the example, in one embodiment, handling status indications sent from test system controller 110 to handling equipment 150 may include inter-alia a “break-contact” indication, when testing of all devices in the group has been completed. In some cases, the “in-contact” indication may be identical to a “start test” indication generated by handling equipment 150 when a group of devices is ready for testing as is known in the art. In some cases, the “break-contact” indication may be identical to an “end-of-test” indication transferred to handling equipment 150 when testing has ended as is known in the art. In some embodiments, at least some of the handling status indications sent between test system controller 110 and handling equipment 150 (for example in-contact, end-of-wafer, end-of-cassette, and/or break-contact) are also provided to each datalog manager 170 in system 100. For example, in some of these embodiments, test system controller 110 may provide handling status indications to each datalog manager 170 directly or via the associated tester operating system and test program server 105 and/or handling equipment 150 may provide handling status indications to each datalog manager 170 directly or via the associated tester operating system and test program server 105. Additionally or alternatively, in some embodiments, the status of testing at each test site controller 115 may be provided by each tester operating system and test program server 105 to the associated datalog manager 170. In one of these embodiments, an “end-of-site-test” indication is provided by each tester operating system and test program server 105 to the associated datalog manager 170 when testing has completed at all test site(s) controlled by associated test site controller 115. In some embodiments, each tester operating system and test program server 105 provides an “end-of-site-test” indication to test system controller 110 when testing at all test site(s) controlled by associated test site controller 115 has ended, and once all devices in the group have completed testing, test system controller 110 generates the break-contact indication. For example, in one of these embodiments, the end-of-site-test for the last test site controller 115 to complete testing (or for the only test site controller 115) is substantially coincident with the generation of the break-contact indication.

In another embodiment, where there is more than one device (test site) associated with a particular test site controller 115, there may be an indication provided each time one of the devices finishes testing, with datalog manager 170 and/or test system controller 110 recognizing when the indication for the last device associated with the particular the test site controller 115 to finish testing has been provided. However, for simplicity of description, it is assumed herein below that in embodiments with a plurality of devices (test sites) associated with a particular test site controller 115 where tester operating system and test program server 105 provides test site testing status indications, tester operating system and test program server 105 provides an end-of-site-test indication when all devices associated with the particular the test site controller 115 have finished testing, and does not provide individual device testing status.

Although FIG. 1 illustrates in-contact, break-contact, end-of-wafer, and end-of-cassette indications being transferred to datalog manager 170, in some embodiments less of these indications, additional indications and/or different indications may be transferred to datalog manager 170. Similarly, although an embodiment where an end-of-site-test indication is transferred to datalog manager 170 has been described, in some embodiments the end-of-site-test indication may not be transferred to datalog manager 170. The meaning and application of indications in managing datalog will be described in more detail further below.

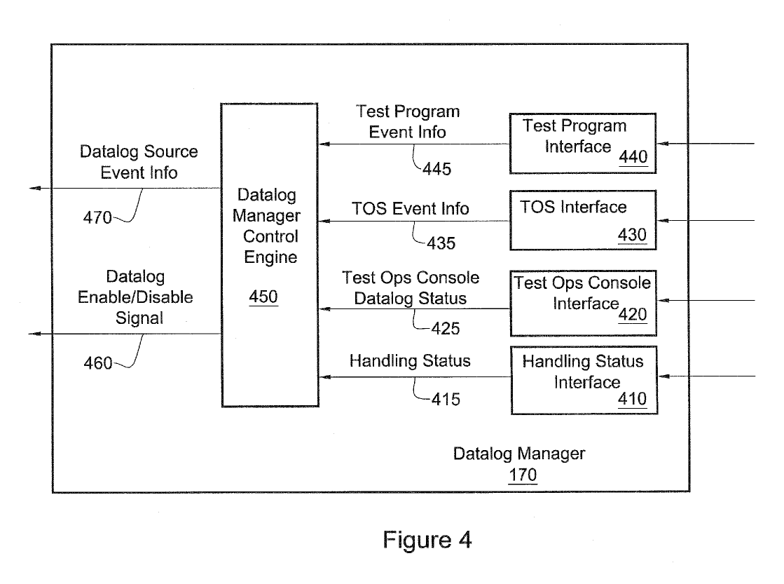

As mentioned above, any datalog manager 170 can be made up of any combination of software, hardware and/or firmware that performs the functions as defined and explained herein. Refer to FIG. 4 which illustrates a block diagram of a particular datalog manager 170 which manages datalog for an associated test site controller 115 according to one embodiment of the present invention.

As shown in the embodiment illustrated in FIG. 4, datalog manager 170, includes any of the following interfaces, inter-alia: test program interface 440 which provides an interface to test program 120 for the associated test site controller 115, TOS interface 430 which provides an interface to tester operating system and test program server 105 for the associated test site controller 115, test operations console interface 420 which provides an interface to test operations console 135, and handling status interface 410 which provides an interface to handling equipment 150 and/or to test system controller 110. For simplicity of description, it is assumed in the embodiments described herein below that handling status indications are received by datalog manager 170 directly from test system controller 110 via handling status interface 410.

In one embodiment, test program event information 445, received via test program interface 440, is provided to datalog manager control engine 450. In some embodiments, additionally or alternatively, TOS event information 435, received via TOS interface 430, is provided to datalog manager control engine 450. For example in one of these embodiments, TOS event information may include an end-of-site-test indication indicating that testing is complete at all test site(s) controlled by the associated test site controller 115. In some embodiments, additionally or alternatively test console datalog status 425, received via test ops console interface 420, is provided to datalog manager control engine 450. For example, in one of these embodiments, test ops datalog status can include an override disabling or enabling indication relating to all test site(s) associated with the particular datalog manager 170 or selectively relating to test site(s) associated with the particular datalog manager 170. In some embodiments, additionally or alternatively, handling status indications 415, received via handling status interface 410, is provided to datalog manager control engine 450. In one of these embodiments, handling status indications 415 may include for example an “in-contact” indication, indicating that a group is ready for testing, a “break-contact” indication, indicating that testing on all devices in a group has completed, and/or an end-of batch indication, indicating that there are no remaining untested devices in a batch (i.e. batch has been completely tested). Examples of end-of-batch signals include end-of-wafer (i.e. wafer completely tested), end-of-cassette (i.e. cassette completely tested), etc.

It should be evident that any of the indications used herein such as “in-contact”, “break-contact”, “end-of-site-test”, “end-of-wafer”, “end-of-cassette”, etc. may take any format suitable for the particular implementation of system 100. For example, in one embodiment, the in-contact indication may take the form of “Ready to test the next semiconductor group”.

In one embodiment, datalog manager control engine 450 periodically polls/queries in order to receive any relevant information/status 445, 435, 425, 415 (including inter-alia indications such as “in-contact”, “break-contact”, “end-of-site-test”. “end-of-wafer”, and/or “end-of-cassette”) that have been generated, whereas in another embodiment relevant generated information/status 445, 435, 425, 415 (including inter-alia indications such as “in-contact”, “break-contact”, “end-of-site-test”, “end-of-wafer”, and/or “end-of-cassette”) are additionally or alternatively received automatically by datalog manager control engine 450.

In some embodiments information and/or status 445, 435, 425, 415 (including inter-alia indications such as “in-contact”, “break-contact”, “end-of-site-test”, “end-of-wafer”, and/or “end-of-cassette”) described with reference to FIG. 4 as entering datalog manager 170 through a particular interface enter via a different interface. For example, in one of these embodiments, indications transferred between test system controller 110 and/or handling equipment 150 and indications originating from tester operating system and test program server 105 may be interfaced to datalog manager 170 through a single interface, for example via TOS inter-face 430. As another example, in one of these embodiments, handling status indications originating from test system controller 110 may be interfaced to datalog manager 170 through a separate interface than handling status indications originating from handling equipment 150. As another example, in one of these embodiments control over data-logging may be asserted from test program 170 indirectly via tester operating system and module control 105 and TOS interface 430 rather than via a separate test program interface 440.

In some embodiments, datalog manager control engine 450 outputs datalog source event information 470 and/or outputs a datalog enable/disable indication 460 to the datalog generation tool 130 for the associated test site controller 115. In some of these embodiments, datalog source event information 470 presents the associated datalog generation tool 130 with information on the datalog event that is the source of raw data (see above discussion) based for example on received test program event information 445 and/or received TOS event information 435. In one of these embodiments, datalog manager control engine 450 may specify in source event information 470 the kinds of raw data that are staged to be data-logged, including for example for each event, an indication that an event has occurred, whether or not the event should be data-logged, and/or the specific nature of the event. Continuing with this embodiment, the specific nature of the event may be used by datalog generation tool 130 to locate the appropriate raw data and/or to properly format the raw data for the type of event.

In some embodiments, datalog manager control engine 450 is configured to selectively output an enable datalog indication 460 (allowing datalog) and/or configured to selectively output a disable datalog indication 460 ( not allowing datalog) to datalog generation tool 130 associated with test site controller 115 based on the condition of one or more inputs 445, 435, 425, and 415 and rules which may vary depending on the implementation. In some of these embodiments, data-logging may thus be controlled by test operation events and functions within or outside of test site controller 115. For example, in some of these embodiments the conditions may include which inputs 445, 435, 425 and/or 415 have been received and/or may include which inputs are anticipated (waited for) but have not yet been received. Continuing with the example, if a “break-contact” indication has been received and “in-contact” indication is anticipated but not yet received, in one of these embodiments it may be assumed that handling equipment 150 is currently preparing the next group for testing. Still continuing with the example, in one of these embodiments the status of the testing (for example whether actual testing is occurring or halted) may in some cases reflect anticipated inputs (for example, actual testing is stopped while “in-contact” indication is awaited, actual testing is occurring on at least one device in a group while “break-contact” is awaited). In another example, where conditions may include which inputs 445, 435, 425 and/or 415 have been received and/or may include which inputs are anticipated (waited for) but have not yet been received, in one embodiment if an end-of-site-test has been received but a “break-contact” is anticipated but not yet received, it may be assumed that the device(s) associated with test site controller 115 has completed testing but now there is a time lag while testing is being completed by other test site controllers 115. In another example, in one embodiment, a rule may state that an “override” disabling indication received from test operations console 135 results in a disabling output indication 460 regardless of the condition of any other inputs. In another example, in one embodiment, a rule may state that an “override” enabling signal received from test operations console 135 results in a disabling output indication 460 regardless of the condition of any other inputs. In another example, in one embodiment automated conditional datalog controls may be embedded within test program 120 (for example, datalog only in the event of device failure), which may be subordinate to master data-log control from test operations console 135 by which an engineer or technician may elect to enable/disable some or all datalog operations. In another example, in one embodiment a rule may state that datalog is disallowed after an in-contact indication is issued by handling equipment 120 until a break-contact is received. In another example, in one embodiment a rule may state that datalog is disallowed after an in-contact indication is issued by handling equipment 120 until a break-contact or end-of-batch indication is received. In another example, in one embodiment a rule may state that datalog is disallowed after an in-contact indication is issued by handling equipment 120 until a break-contact, end-of-site-test or end-of-batch indication is received. In another example, in one embodiment a rule may state that datalog should be postponed until the completion of testing for a batch of devices, for example, after testing has been completed on all of the devices within a single wafer, cassette, and/or package holder. Other rules are possible in various embodiments, some of which are described or are apparent from what is described elsewhere herein.

Each of the modules in FIG. 4 may be made up of any combination of software, hardware and/or firmware that performs the functions as defined and explained herein. In some embodiments, datalog manager 170 may comprise fewer, more, and/or different modules than those shown in FIG. 4. In some embodiments of datalog manager 170, the functionality described herein may be divided into fewer, more and/or different modules than shown in FIG. 4. For example, in one of these embodiments, there may be fewer, more and/or different interfaces receiving inputs than shown in FIG. 4. In some embodiments, datalog manager 170 may include more, less and/or different functionality than described herein. For example, in one of these embodiments, datalog manager 170 may receive feedback from datalog generation tool 130. The functionality of datalog manager 170 may be concentrated in one location or dispersed over more than one location.

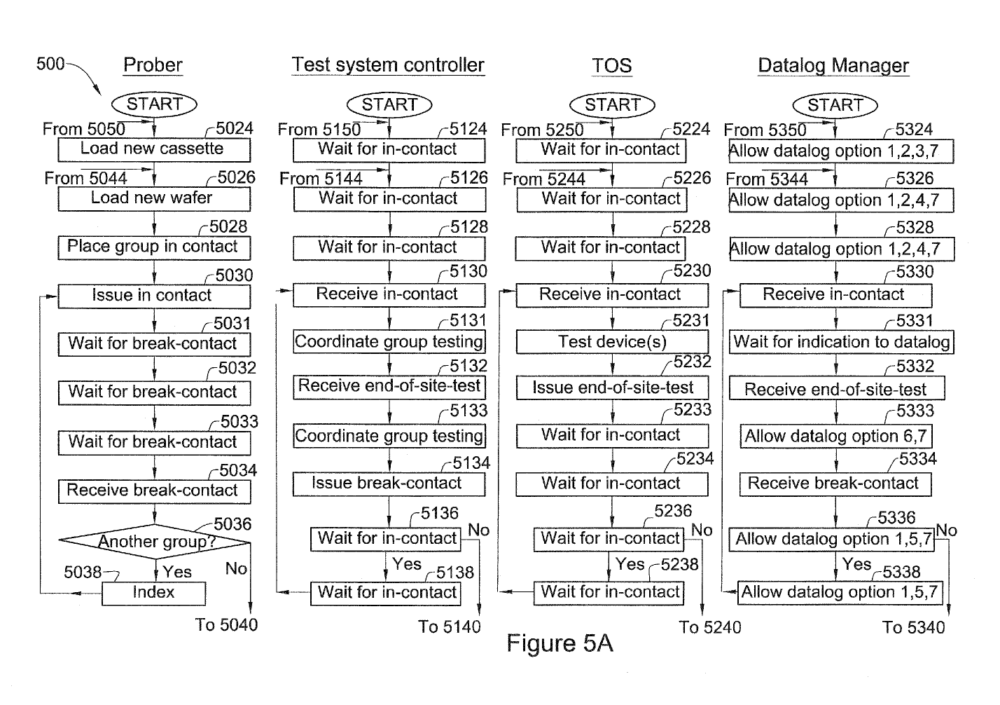

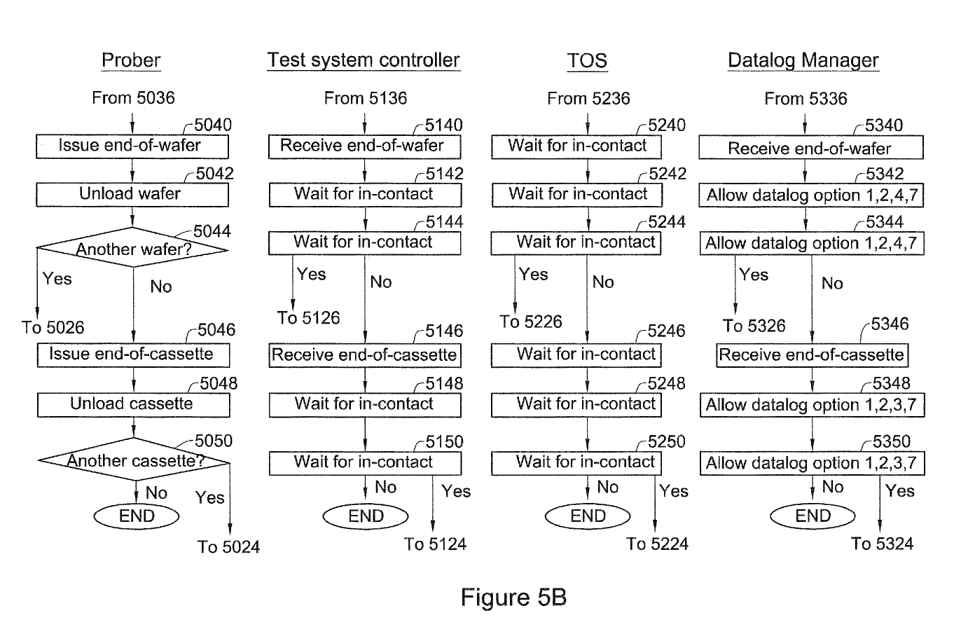

FIG. 5 illustrates a method 500 of datalog management, according to an embodiment of the present invention.

In the embodiment illustrated in FIG. 5, parallel processes are described for prober 150a, test system controller 110, datalog manager 170 associated with any one of the N test site controllers 115, and tester operating system and test program server (TOS) 105 associated with the same test site controller 115. For ease of description, the reference numerals for prober 150a, test system controller 110, datalog manager 150, tester operating system and test program server (TOS) 105, and test site controller 115, are omitted in the description of method 500. In the illustrated embodiment of FIG. 5, there is a difference of 100 between reference numerals of test system controller stages and reference numerals of prober stages which occur in parallel. There is a difference of 200 between reference numerals of tester operating system and test program server stages and reference numerals of prober stages which occur in parallel. There is a difference of 300 between reference numerals of datalog manager stages and reference numerals of prober stages which occur in parallel.

For simplicity of description a number of non-limiting assumptions are made in the described embodiments of method 500. First, it is assumed in the described embodiments that no manual over-ride enable or disable indication is inputted via test operations console 135. Second, it is assumed in the described embodiments that data-logging is not allowed during actual testing. Third, it is assumed in the described embodiments that the testing includes a wafer sort operation using a prober (such as prober 150a). Fourth, it is assumed in the described embodiments that there is at least one group of (at least one) devices on each wafer, at least one wafer on each cassette, and at least one cassette in each lot. Fifth, the described embodiments ignore activity (if any) by the prober, the test system controller, and the tester operating system and test program server that is unrelated to datalog management. Sixth, the described embodiments assume that the tester operating system and test program server receives the “in-contact” indication but no other indications originating at the prober or the test system controller. It should be evident that in some embodiments of the invention any of the above assumptions may not be made.

Method 500 discussed inter-alia six possible embodiments for managing data-logging. In the first embodiment (option 1), the datalog manager allows data-logging during any preparation intervals in which the prober is preparing a group for testing. In the second embodiment (option 2) the datalog manager allows data-logging during preparation activity which includes unloading/loading of any type of batch. In the third embodiment (option 3), the datalog manager allows data-logging during preparation activity which includes unloading/loading of a cassette (specific type of batch). In the fourth embodiment (option 4), the datalog manager allows data-logging during preparation activity which includes unloading/loading of a wafer (specific type of batch) and subsequent contacting of the first group in the loaded wafer. In the fifth embodiment (option 5), the datalog manager allows data-logging during preparation activity which includes indexing (specific type of preparation). In the sixth embodiment assuming N>1 (option 6), the datalog manager allows data-logging during the time lag between when testing ends for all test site(s) controlled by the associated test site controller and testing ends for all test sites (controlled by the N test site controllers). In the seventh embodiment assuming N>1 (option 7), the datalog manager allows data-logging during the time lag between when testing ends for all test site(s) controlled by the associated test site controller and testing ends for all test sites (controlled by the N test site controllers) and also during any preparation intervals in which the prober is preparing a group for testing. These seven embodiments are presented for the sake of further illustration to the reader but should not be construed as limiting.

In some embodiments of method 500, an indication issued by the prober that is received by the test system controller and/or by the tester operating system and test program server may in some cases be received by the datalog manager. In one of these embodiments, the indication may be independently received by the datalog manager and by the test system controller/tester operating system and program server. In one of these embodiments, the indication may be received by the datalog manager and forwarded to the test system controller/tester operating system and test program server. In one of these embodiments, the indication may be received by test system controller/tester operating system and test program server and forwarded to the datalog manager.

In some embodiments of method 500, an indication issued by the test system controller which is received by the prober may in some cases be received by the datalog manager. In one of these embodiments, the indication may be independently received by the datalog manager and by the prober. In one of these embodiments, the indication may be received by the datalog manager and forwarded to the prober. In one of these embodiments, the indication may be received by the prober and forwarded to the datalog manager.

In some embodiments of method 500, an end-of-site-test indication issued by the tester operating system and program server may in some cases be received by the datalog manager and/or by the test system controller. In some of these embodiments, the indication may be received independently by the datalog manager and the test system controller, may be received by the datalog manager and forwarded to the test system controller, or may be received by the test system controller and forwarded to the datalog manager.

In some cases, different indications may be transferred via different paths. There is no limitation in the described embodiments on the path for transferring indications.

In the illustrated embodiment of FIG. 5, in stage 5024, the prober loads a new cassette of wafers. The test system controller and the tester operating system and test program server wait for an in-contact indication (stage 5124 and 5224 respectively). Under options 1, 2, 3, or 7 the datalog manager allows datalog, whereas under options 4, 5, or 6 data-logging is not allowed (stage 5324). In stage 5026, the prober loads a new wafer onto the prober chuck. The test system controller and the tester operating system and test program server still wait for an in-contact indication (stage 5126 and 5226 respectively). Under options 1, 2, 4, or 7 the datalog manager allows datalog whereas under options 3, 5, or 6 data-logging is not allowed (stage 5326). In stage 5028, the prober places a group of devices on the wafer in electrical contact with the interface unit (for example probecard 160a). The test system controller and the tester operating system and test program server wait for an in-contact indication (stage 5128 and 5228 respectively). Under options 1, 2, 4, or 7 the datalog manager allows datalog whereas under options 3, 5, or 6 data-logging is not allowed (stage 5328). If data-logging is not allowed in any of stages 5324, 5326 or 5328 datalog manager waits for the appropriate indication to allow data-logging according to the option followed. In another embodiment, datalog is not allowed for any option during the initial execution of stages 5324, 5326, or 5328 (i.e. when no devices have yet been tested), for example because of a lack of data to be logged prior to testing.

In stage 5030 of the embodiment illustrated in FIG. 5, the prober issues an “in-contact” indication indicating that there is a group prepared for testing. In stages 5130, 5230 and 5330 the test system controller, the tester operating system and test program server, and the datalog manager respectively receive the “in-contact” indication which in the described embodiment respectively notifies the test system controller to coordinate the testing of the group of devices, the tester operating system and test program server to start actual testing at the associated test site(s), and the datalog manager to not allow data-logging. Alternatively, the datalog manager may not receive (or may receive and ignore) an “in-contact” indication in stage 5330 if the datalog manager was already not allowing data-logging.

In stage 5231 of the embodiment illustrated in FIG. 5, the tester operating system and test program server tests the device(s) at the associated test site(s) while in stage 5131 the test system controller coordinates the testing of the group. The prober in stage 5031 waits for the next “break-contact” indication, whereas the datalog manager in stage 5331 waits for an indication to allow data-logging as appropriate for the datalog option. For example, in some embodiments if data-logging is allowed during the time lag between completion of testing at the test site(s) controlled by the associated test site controller and completion for all test site controllers, then datalog manager waits in stage 5331 for an “end-of-site-test” indication, whereas if data-logging is not allowed during the time lag but allowed during indexing, the datalog manager waits for a “break-contact” indication. In another embodiment, where the datalog manager would not allow data-logging during the time lag nor during an indexing stage anticipated to follow a “break-contact” indication, the datalog manager instead waits in stage 5331 for the appropriate end-of-batch indication for allowing data-logging in accordance with the option followed by the datalog manager.

In the illustrated embodiment, it is assumed that the associated test site controller is not the last test site controller to complete testing. In stage 5232, the tester operating system and test program server issues an end-of-site-test, indicating that testing has ended for all test site(s) controlled by the associated test site controller. In stage 5132 and stage 5332, the test system controller and the datalog manager respectively receive the end-of-site-test. In another embodiment, the datalog manager does not necessarily receive (or receives and ignores) the end-of-site-test, for example because the indication does not cause the datalog manager to switch to allowing data-logging (for example under options 1, 2, 3, 4, 5). In another embodiment, the test system controller does not receive the end-of-site-test issued by tester operating system and test program server. In stage 5032, the prober still waits for a “break-contact” indication. In stage 5333, the datalog manager allows data-logging under option 6 or 7 but does not allow data-logging under options 1, 2, 3, 4 or 5. In stage 5233 the tester operating system and test program server waits for an “in-contact” indication (to begin testing again). In stage 5133 the tester continues to coordinate group testing until the last test site has completed testing (i.e. until all the devices in the group have completed testing). In stage 5033 the prober still waits for a “break-contact” indication. In another embodiment, where there is only one test site controller or the associated test site controller is the last to finish testing, stages 5032, 5132, 5232, 5332, 5033, 5133, 5233, and 5333 may be omitted. In stage 5134, when all devices have completed testing, the test system controller issues a “break-contact” indication which is received by the prober and the datalog manager in stages 5034 and 5334 respectively. In other embodiments, the datalog manager may not receive (or may receive and ignore) the “break-contact” indication, for example because the “break-contact” indication does not cause the datalog manager to switch to allowing data-logging or disallowing data-logging. Continuing with this example, in some embodiments the “break-contact” may cause a switch to allowing data-logging (option 1 or 5) or to disallowing data-logging (option 6), but under options 2, 3, or 4, the “break-contact” does not cause data-logging to begin to be allowed, nor under option 7 does the “break-contact” cause data-logging to stop being allowed. In stage 5234, the tester operating system and test program server continues to wait for an “in-contact” indication. In another embodiment where there is only one test site controller, only one of the end-of-site-test indication or the break-contact indication may be required to be issued, because either would indicate that testing has been completed for the group and that the prober may remove electrical contact.

In the described embodiment referring to FIG. 5, the datalog manager assumes that there is another (untested) group on the wafer to be tested unless notified otherwise. Therefore, while the prober in stage 5036 is determining whether there is another (untested) group on the wafer to prepare for testing, the test system controller and the tester operating system and test program server wait for an in-contact signal (stage 5136 and 5236 respectively) and in stage 5336 the datalog manager allows data-logging under options 1, 5, or 7. Under options 2, 3, 4, or 6, the datalog manager does not allow data-logging because the datalog manager assumes that no unloading/loading or time lag will be occurring unless notified otherwise.

In the described embodiment referring to FIG. 5, assuming that there is another (untested) group (yes to stage 5036), then in stage 5038 the prober indexes to another group on the wafer. In stage 5138 and 5238 the test system controller and the tester operating system and test program server respectively wait for an in-contact indication. In stage 5338, under option 1, 5, or 7 the datalog manager allows data-logging. Under option 2, 3, 4, or 6, the datalog manager does not allow data-logging. Method 500 then iterates back to 5030, 5130, 5230, and 5330.

In the described embodiment referring to FIG. 5, if instead there are no untested devices on the wafer (no to stage 5036), then in stage 5040, the prober issues an end-of-wafer indication. In stage 5140, the test system controller receives the end-of-wafer and notes the change in wafer status. In stage 5340, the datalog manager receives the end-of-wafer-indication. In another embodiment, the datalog manager may not receive (or receive and ignore) the end-of-wafer indication, for example if the indication does not cause a transition from allowing data-logging to not allowing data-logging or from not allowing data-logging to allowing data-logging. In stage 5240, the tester operating system and test program server continues to wait for an “in-contact” indication.

In the illustrated embodiment of FIG. 5, in stage 5042, the prober unloads the tested wafer from the prober chuck. In stage 5142 the test system controller and the tester operating system and test program server wait for an “in-contact” indication in stages 5142 and 5242 respectively. In stage 5342, the datalog manager allows data-logging under option 1, 2, 4, or 7. Under options 3, 5, or 6 data-logging is not allowed and instead the datalog manager waits for the appropriate indication to allow data-logging according to the option followed.

In the described embodiment referring to FIG. 5, the datalog manager assumes that there is another untested wafer on the cassette, unless notified otherwise. Therefore, while the prober in stage 5044 is determining whether there is another (untested) wafer on the cassette to load and the test system controller and the tester operating system and test program server wait for an in-contact indication (stage 5144 and 5244 respectively), the datalog manager in stage 5344 allows data-logging under option 1, 2, 4, or 7. Under options 3, 5, or 6 data-logging is not allowed and instead the datalog manager waits for the appropriate indication to allow data-logging according to the option followed.

In the embodiment illustrated in FIG. 5, if there is another (untested) wafer on the cassette (yes to stage 5044), then method 500 iterates back to stages 5026, 5126, 5226 and 5326. Otherwise if there is no untested wafer on the cassette (no to stage 5044) then the prober issues an end-of-cassette indication in stage 5046. The tester operating system and the datalog manager receive the end-of-cassette indication in stages 5146 and 5346 respectively. In another embodiment, the datalog manager may not receive (or may receive and ignore) the end-of-cassette indication for example if the indication does not cause a transition from allowing data-logging to not allowing data-logging or from not allowing data-logging to allowing data-logging. In stage 5246, the tester operating system and test program server continues to wait for an “in-contact” indication.

In the illustrated embodiment of FIG. 5, in stage 5048, the prober unloads the tested cassette. In stage 5148 and 5248 the test system controller and the tester operating system and test program server respectively wait for a start-test indication. In stage 5348, the datalog manager allows data-logging under option 1, 2, 3, or 7. Under options 4, 5, or 6 data-logging is not allowed and instead the datalog manager waits for the appropriate indication to allow data-logging according to the option followed.

In the described embodiment referring to FIG. 5, the datalog manager assumes that there is another untested cassette in the lot unless notified otherwise. Therefore, while the prober in stage 5050 is determining whether there is another (untested) cassette in the lot to load and the test system controller and the tester operating system and test program server wait for an in-contact signal (stage 5150 and 5250 respectively), the datalog manager in stage 5350 allows data-logging under options 1, 2, 3, or 7. Under options 4, 5, or 6 data-logging is not allowed and instead the datalog manager waits for the appropriate indication to allow data-logging according to the option followed.

In the embodiment illustrated in FIG. 5, if there is another (untested) cassette in the lot (yes to stage 5050), then method 500 iterates back to stages 5024, 5124, 5224 and 5324. In another embodiment, method 500 iterates back to stages 5024, 5124, 5224 and 5324 but in the execution of stages 5326 and 5328 in this embodiment, datalog is allowed under options 1, 2, 3 or 7 and not allowed under options 4, 5, and 6 (because it is assumed that the datalog manager does not know when the prober moves from loading the new cassette to loading the new wafer). Otherwise if there is no untested cassette left in the lot (no to stage 5050) then method 500 ends. In one embodiment, for example the prober may issue an end-of-lot indication when all cassettes have been tested in the lot, notifying the test system controller, tester operating system and test program server and/or the datalog manager that the lot has been completed. In one embodiment method 500 restarts the next time a lot is loaded for testing.

In other embodiments of the invention, fewer, more, or different stages than those shown in FIG. 5 may be executed. In other embodiments, the stages may be executed in a different order than shown in FIG. 5 and/or different stages may be executed in parallel. Each of the stages of method 500 may be executed automatically (without user intervention), semi-automatically and/or manually, depending on the embodiment.

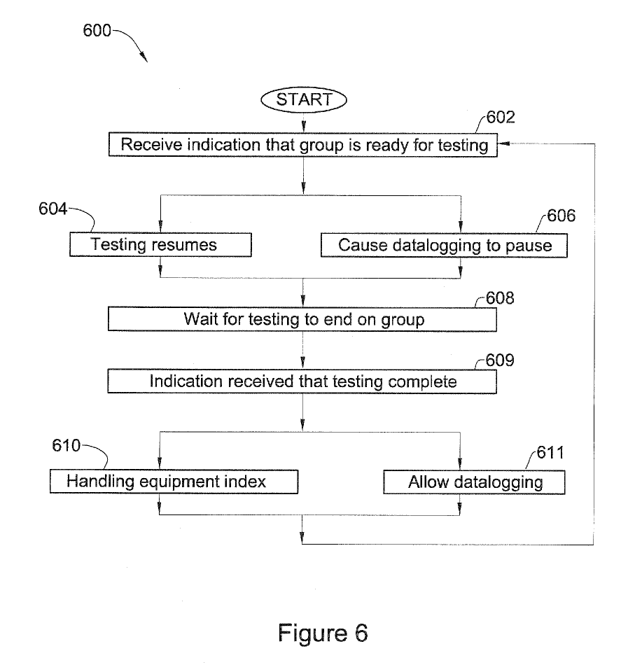

FIG. 6 is a flowchart of a method 600 for datalog management, according to an embodiment of the present invention. For simplicity of description it is assumed in method 600 that data-logging is allowed only during indexing. For simplicity of description, it is also assumed that there is only one device (one test site), per test site controller 115. It should be evident that in another embodiment of the invention, these assumptions may not be made.

In stage 602 each datalog manager 170 receives an indication that a new group is ready for testing, for example a new device (in a sequential testing environment) or a new touchdown (in a parallel testing environment). For example, each datalog manager 170 may receive an “in-contact” indication.

Stages 604 and 606 are then executed in parallel. In stage 604 each tester operating system and test program server 105 begins testing a device from the new group at the associated test site. In stage 606, depending on the specifics of the configuration used, each datalog manager 170 communicates to the associated datalog generation tool 130 to pause data logging. In other embodiments of stage 606, data-logging relating to one or more test sites may be allowed while testing, for example if manually forced to datalog during testing by test operations console 135, or for example in some cases if datalog for earlier events had not yet been completed.

In stage 608, each datalog manager waits for a signal that testing has ended on the group. For example in one embodiment, there is an “break-contact” signal from the test system controller 110 which indicates that testing of the group (for example one device in sequential testing or a touchdown in parallel testing) has been completed.

In stage 609, when testing of the currently contacted device or touchdown has been completed, each datalog manager 170 receives a signal that testing has ended, for example the “break-contact” signal generated by test system controller 110.

Stages 610 and 612 are then executed in parallel. In stage 610, handling equipment 150 begins an indexing operation to contact a new group.

In stage 612, each datalog manager 170 indicates to the associated datalog generation tool 130 that data-logging is allowed. For example if data-logging was halted then the indication in stage 612 can cause data-logging to resume. As another example, if data-logging is already taking place, the indication in stage 612 may indicate that data-logging continues to be allowed. In another embodiment of stage 612, one or more datalog manager(s) 130 associated may not indicate to the associated datalog generation tool(s) 130 that data-logging is allowed, for example if manually disabled from test operations console 135, or for example if there is no data to datalog, or for example if data-logging is already taking place.

Method 600 repeats. In one embodiment, when there are no more groups on a wafer or a package holder to test, an “in-contact” indication will not be received in stage 602 and therefore method 600 will end. In another embodiment, additionally or alternatively, an indication originating from handling equipment 150 such as “end-of-wafer” may be received by each datalog manager 170 indicating that there are no more groups on the wafer to test, causing method 600 to end. In one embodiment, method 600 restarts the next time a wafer or package holder is loaded for testing.

In other embodiments of the invention, fewer, more, or different stages than those shown in FIG. 6 may be executed. In other embodiments, the stages may be executed in a different order than shown in FIG. 6 and/or different stages may be executed in parallel. Each of the stages of method 600 may be executed automatically (without user intervention), semi-automatically and/or manually depending on the embodiment.

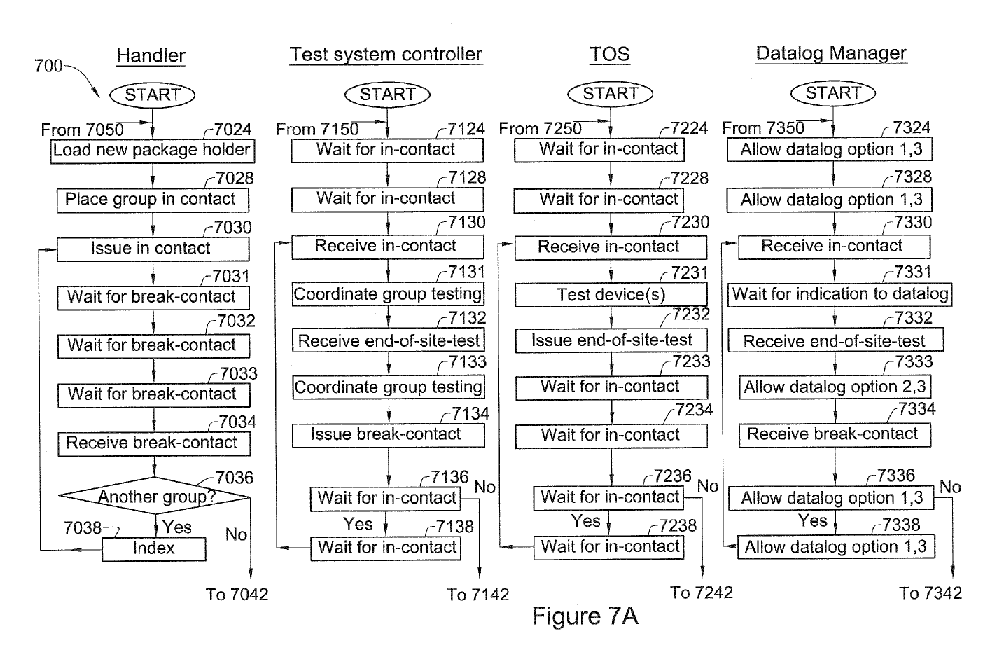

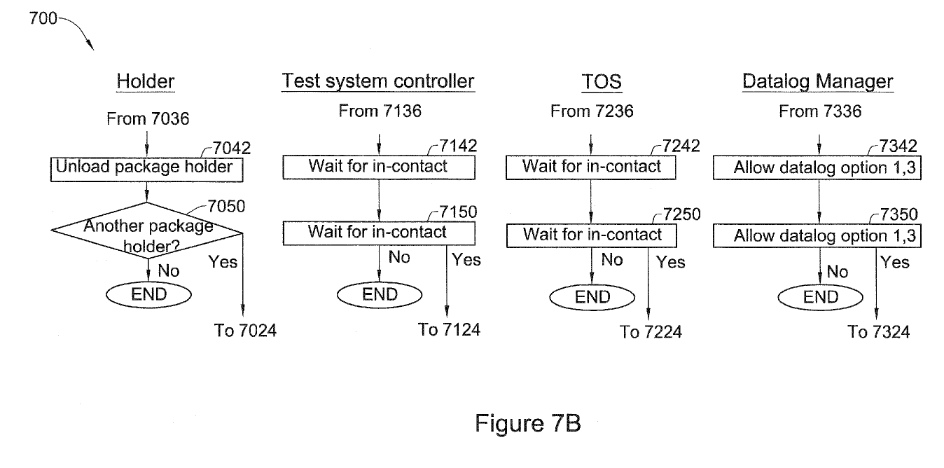

FIG. 7 is a flowchart of a method 700 for datalog management, according to an embodiment of the present invention.

In the embodiment illustrated in FIG. 7, parallel processes are described for handler 150b, test system controller 110 datalog manager 170 associated with any one of the N test sites controllers 115, and tester operating system and test program server (TOS) 105 associated with the same test site controller 115. For ease of description, the reference numerals for handler 150b, test system controller 110, datalog manager 150, tester operating system and test program server (TOS) 105, and test site controller 115 are omitted in the description of method 700. In the illustrated embodiment of FIG. 7, there is a difference of 100 between reference numerals of test system controller stages and reference numerals of handler stages which occur in parallel. There is a difference of 200 between reference numerals of tester operating system and test program server stages and reference numerals of handler stages which occur in parallel. There is a difference of 300 between reference numerals of datalog manager stages and reference numerals of handler stages which occur in parallel.

For simplicity of description a number of non-limiting assumptions are made in the described embodiments of method 500. First, it is assumed in the described embodiments that no manual over-ride enable or disable indication is inputted via test operations console 135. Second, it is assumed in the described embodiments that data-logging is not allowed during actual testing. Third, it is assumed in the described embodiments that the testing includes a final test sequence using a handler (such as handler 150b). Fourth, it is assumed in the described embodiments that there is at least one group of (at least one) devices in each package holder and at least one package holder in each lot. Fifth, it is assumed in the described embodiments that there are no end-of-batch (for example end-of package holder) indications provided by the handler. Sixth, the described embodiments ignore activity (if any) by the handler, the test system controller, and the tester operating system and test program server that are unrelated to datalog management. Seventh, the described embodiments assume that the test operation system and test program server only receives the “in-contact” indication, but no other indications originating at the handler or the test system controller. It should be evident that in some embodiments of the invention any of the above assumptions may not be made.

Method 700 discussed inter-alia three possible embodiments for managing data-logging. In the first embodiment (option 1), the datalog manager allows data-logging during any preparation intervals in which the handler is preparing a group for testing. In the second embodiment assuming N>1 (option 2) the datalog manager allows data-logging during the time lag between when testing ends for all test site(s) controlled by the associated test site controller and testing ends for all test sites (controlled by the N test site controllers). In the third embodiment assuming N>1 (option 3) the datalog manager allows data-logging during the time lag between when testing ends for all test site(s) controlled by the associated test site controller and testing ends for all test sites (controlled by the N test site controllers) and during any preparation intervals in which the handler is preparing a group for testing. These three embodiments are presented for the sake of further illustration to the reader but should not be construed as limiting.

In some embodiments of method 700, an indication issued by the handler that is received by the test system controller and/or by the tester operating system and test program server may in some cases be received by the datalog manager. In one of these embodiments, the indication may be independently received by the datalog manager and by the test system controller/tester operating system and program server. In one of these embodiments, the indication may be received by the datalog manager and forwarded to the test system controller/tester operating system and test program server. In one of these embodiments, the indication may be received by test system controller/tester operating system and test program server and forwarded to the datalog manager.

In some embodiments of method 700, an indication issued by the test system controller which is received by the handler may in some cases be received by the datalog manager. In one of these embodiments, the indication may be independently received by the datalog manager and by the handler. In one of these embodiments, the indication may be received by the datalog manager and forwarded to the handler. In one of these embodiments, the indication may be received by the handler and forwarded to the datalog manager.

In some embodiments of method 700, an end-of-site-test indication issued by the tester operating system and program server may in some cases be received by the datalog manager and/or by the test system controller. In some of these embodiments, the indication may be received independently by the datalog manager and the test system controller, may be received by the datalog manager and forwarded to the test system controller, or may be received by the test system controller and forwarded to the datalog manager.

In some cases, different indications may be transferred via different paths. There is no limitation in the described embodiments on the path for transferring indications.

In the illustrated embodiment of FIG. 7, in stage 7024, the handler loads a new package holder of devices. The test system controller and the tester operating system and test program server wait for an in-contact indication (stage 7124 and 7224 respectively), and under option 1 or 3 datalog manager allows datalog (stage 7324). Under option 2, datalog is not allowed. In stage 7028, the handler places the first group in the package holder to be tested in electrical contact with the interface unit (for example loadboard 160b). For example, the one or more devices included in the first group are socketed (placed into test sockets). The test system controller and the tester operating system and test program server still wait for an in-contact-indication (stage 7128 and 7228 respectively), and the datalog manager allows datalog under option 1 or 3 but not under option 2 (stage 7328). If data-logging is not allowed in stages 7324 or 7328 (for example under option 2), then datalog manager waits for the appropriate indication to allow data-logging according to the option followed. In another embodiment, datalog is not allowed during the initial execution of stages 7324 or 7328 (i.e. when no devices have yet been tested), for example because of a lack of data to be logged prior to testing.

In stage 7030 of the embodiment illustrated in FIG. 7, the handler issues an “in-contact” indication indicating that there is a group ready for testing. In stage 7130, 7230, and 7330 the test system controller, the tester operating system and test program server and the datalog manager respectively receive the in-contact indication which, in the described embodiment, respectively notifies the test system controller to coordinate the testing of the group of devices, the tester operating system and test program server to start actual testing at the associated test site(s), and the datalog manager to not allow data-logging. Alternatively, the datalog manager may not receive (or may receive and ignore) an “in-contact” indication in stage 7230 if the datalog manager was already not allowing data-logging.

In stage 7231 of the embodiment illustrated in FIG. 7, the tester operating system and test program server tests the device(s) at the associated test site(s) while in stage 7131 the test system controller coordinates the testing of the group. The handler in stage 7031 waits for the next “break-contact” indication, whereas the datalog manager in stage 7331 waits for an indication to allow data-logging as appropriate for the datalog option. For example, in some embodiments if data-logging is allowed during the time lag between completion of testing at the test site(s) controlled by the associated test site controller and completion for all test site controllers, then datalog manager waits in stage 7331 for an “end-of-site-test” indication, whereas if data-logging is not allowed during the time lag but allowed during indexing, the datalog manager waits for a “break-contact” indication.

In the illustrated embodiment, it is assumed that the associated test site controller is not the last test site controller to complete testing. In stage 7232, the tester operating system and test program server issues an end-of-site-test, indicating that testing has ended for all test site(s) controlled by the associated test site controller. In stage 7132 and stage 7332, the test system controller and the datalog manager respectively receive the end-of-site-test. In another embodiment, the datalog manager does not necessarily receive (or receives and ignores) the end-of-site-test for example because the indication does not cause the datalog manager to switch to allowing data-logging (for example under option 1). In another embodiment, the test system controller does not receive the end-of-site-test issued by tester operating system and test program server. In stage 7032, the handler still waits for a “break-contact” indication. In stage 7333, the datalog manager allows data-logging under option 2 or 3 but does not allow data-logging under option 1. In stage 7233 the tester operating system and test program server waits for an “in-contact” indication (to begin testing). In stage 7133 the tester continues to coordinate group testing until the last test site has completed testing (i.e. until all the devices in the group have completed testing). In stage 7033 the handler still waits for a “break-contact” indication. In another embodiment, where there is only one test site controller or the associated test site controller is the last to finish testing, stages 7032, 7132, 7232, 7332, 7033, 7133, 7233, and 7333 may be omitted. In stage 7134, when all devices have completed testing the test system controller issues a “break-contact” indication which is received by the handler and the datalog manager in stages 7034 and 7334 respectively. In other embodiments, the datalog manager may not receive (or may receive and ignore) the break-contact indication for example because the break-contact indication does not cause the datalog manager to switch to allowing data-logging or disallowing data-logging such as per option 3. In stage 7234, the tester operating system and test program server continues to wait for an “in-contact” indication. In another embodiment where there is only one test site controller, only one of the end-of-site-test indication or the break-contact indication may be required to be issued, because either would indicate that that testing has been completed for the group and that the handler may remove electrical contact.

In the described embodiment referring to FIG. 7, assuming that there is another (untested) group (yes to 7036), in stage 7038 the handler indexes to another group in the package holder, for example unsocketing the tested group of device(s) and socketing an untested group of device(s). In stages 7136 and 7138, the test system controller waits for an in-contact indication. In stages 7236 and 7238 the tester operating system and test program server waits for an in-contact indication. The datalog manager allows data-logging under option 1 or 3 but not under option 2 in stage 7336 and 7338. Method 700 then iterates back to 7030, 7130, 7230 and 7330.

In the described embodiment referring to FIG. 7, if instead there are no untested devices in the package holder (no to stage 7036), then in stage 7042, the handler unloads the package holder. In stages 7142, 7150 and 7242, 7250 respectively the test system controller and the tester operating system and test program server wait for an in-contact indication. In stages 7342 and 7350 the datalog manager allows data-logging under option 1 or 3 but not under option 2.

In the embodiment illustrated in FIG. 7, if there is another (untested) package holder in the lot (yes to stage 7050), then method 700 iterates back to stages 7024, 7124, 7224 and 7324. Otherwise if there are no untested package holders in the lot (no to stage 7050) then method 700 ends. In one embodiment, method 700 restarts the next time a lot is loaded for testing.

In other embodiments of the invention, fewer, more, or different stages than those shown in FIG. 7 may be executed. In other embodiments, the stages may be executed in a different order than shown in FIG. 7 and/or different stages may be executed in parallel. Each of the stages of method 700 may be executed automatically (without user intervention), semi-automatically and/or manually, depending on the embodiment.

In some embodiments, datalog management may be allowed regardless of whether testing is occurring or waiting/preparation for testing is instead occurring. In these embodiments, the datalog manager (for example datalog manager 170) does not necessarily need to distinguish between when testing is occurring and when preparation for testing or waiting is occurring, because the distinction does not impact on the decision of whether or not to allow data-logging. Therefore in some of these embodiments, FIGS. 1 and 4 may be simplified so that the in-contact, end-of batch, end-of-site-test and/or break-contact indications are not necessarily provided to datalog manager control engine 450 in datalog manager 170. In some of these embodiments, datalog is allowed at any time during the processing, provided there is data to log and no disabling indication is received from test operations console 135. For example, in one of these embodiments, once testing is completed on a group of devices, handling equipment 150 proceeds to prepare a new group for testing, regardless of whether data-logging is occurring or not. Continuing with this embodiment, once the new group is ready for testing, testing begins, regardless of whether data-logging is occurring or not.

It will also be understood that the system according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

While the invention has been shown and described with respect to particular embodiments, it is not thus limited. Numerous modifications, changes and improvements within the scope of the invention will now occur to the reader.

1. A system for managing logging of semiconductor test data, comprising:
handling equipment configured to prepare a semiconductor device for testing;
a datalog generation tool configured to log data relating to semiconductor testing; and
a datalog manager configured to at least occasionally allow said datalog generation tool to log data while said handling equipment is preparing said device for testing.

2. The system of claim 1, further comprising an interface unit wherein said preparing includes placing a group including said device in electrical contact with said interface unit and wherein said datalog manager allows said datalog generation tool to log data while said handling equipment is placing said group in electrical contact.

3. The system of claim 2, wherein said group includes a single device.

4. The system of claim 2, wherein said group includes a plurality of devices which will be tested in parallel.

5. The system of claim 1, further comprising an interface unit wherein said preparing includes removing a previously tested group of at least one device from electrical contact with said interface unit, and wherein said datalog manager allows said datalog generation tool to log data while said handling equipment is removing said previously tested group from electrical contact.

6. The system of claim 1, wherein said preparing includes loading a batch of devices including said device, and wherein said datalog manager allows said datalog generation tool to log data while said handling equipment is loading said batch.

7. The system of claim 1, wherein said preparing includes unloading a previously tested batch of devices, and wherein said datalog manager allows said datalog generation tool to log data while said handling equipment is unloading said previously tested batch.

8. The system of claim 1, wherein said preparing includes indexing, and wherein said datalog manager allows said datalog generation tool to log data while said handling equipment is indexing.

9. The system of claim 1, further comprising a test system controller, wherein said datalog manager being configured to at least occasionally allow includes said datalog manager being configured to receive a “break-contact” indication issued by said test system controller after testing has ended on a previous group of at least one device and being configured to then begin or continue to allow said datalog generation tool to log data.

10. The system of claim 1, wherein said datalog manager being configured to at least occasionally allow includes said datalog manager being configured to receive an end-of-batch indication issued by said handling equipment when there are no remaining untested devices in a previous batch and being configured to then begin or continue to allow said datalog generation tool to log data.

11. The method of claim 10, wherein said end-of-batch indication includes an end-of-wafer indication or an end-of-cassette indication.

12. The system of claim 1, wherein said datalog manager being configured to at least occasionally allow includes said datalog manager being configured to recognize when anticipating an “in-contact” indication, and to allow said datalog generation tool to log data while anticipating said “in-contact” indication.

13. The system of claim 1, further comprising: a test operations console configured to provide enable and disable indications to said datalog manager; wherein said datalog manager being configured to at least occasionally allow includes said datalog manager being configured to not allow said datalog generation tool to log data while said handling equipment is preparing said device for testing if a disable indication is received from said test operations console.

14. The system of claim 1, wherein said datalog manager is further configured to receive an “in-contact” indication issued by said handling equipment when a group of at least one device which includes said device is ready for testing and to then begin or continue to prevent said datalog generation tool from logging data.

15. The system of claim 1, further comprising: a tester operating system and test program server configured to test said prepared device.

16. The system of claim 15, wherein said tester operating system and test program server is configured to test at least one device including said device from a group undergoing testing in parallel, wherein said datalog manager is further configured to at least occasionally allow said datalog generation tool to log data after said tester operating system and test program server has completed testing on said at least one device, while at least one other device in said group is still being tested.

17. A module for managing datalog, comprising:
at least one interface configured to at least receive a first indication that a device is being prepared for testing and a second indication that said device is ready for testing; and
a datalog manager control engine configured to schedule logging of data based at least partly on any received first and second indications.

18. The datalog manager module of claim 17, wherein said first indication is a break-contact indication, indicating that testing has completed on a group of at least one device preceding a group of at least one device which includes said device.

19. The datalog manager module of claim 17, wherein said first indication is an end-of-batch indication, indicating that there are no remaining untested devices in a batch preceding a batch which includes said device.

20. The datalog manager module of claim 17, wherein said second indication is an in-contact indication, indicating that a group of at least one device including said device is in electrical contact for testing.

21. The datalog manager module of claim 17, wherein said at least one interface includes an interface configured to receive enable and disable inputs originating from a test operations console.

22. The datalog manager module of claim 21, wherein said datalog manager control engine being configured to schedule logging of data includes said datalog manager control engine being configured to schedule logging of data based at least partly on any received first and second indications and any enable and disable inputs received from said test operations console.

23. The datalog manager module of claim 17, wherein said at last one interface includes an interface configured to receive an end-of-site-test indication originating from a tester operating system and test program server, indicating that said device and any other devices tested by said tester operating system and test program server has completed testing.

24. The datalog manager module of claim 23, wherein said datalog manager control engine is configured to schedule logging of data based at least partly on any received first and second indications and any end-of-site-test indications received from said tester operating system and test program server.

25. A method of managing logging of semiconductor test data, comprising:
allowing logging of semiconductor test data during at least part of a time interval in which a group of at least one device is being prepared for testing by handling equipment.

26. The method of claim 25, further comprising:
preventing logging of semiconductor test data during at least part of a time interval in which said prepared group is being tested.

27. The method of claim 26, further comprising: receiving an enable indication, wherein said preventing logging includes: after receiving said enable indication, allowing logging of semiconductor test data relating to at least one test site during at least part of a time interval in which said group of devices is being tested.

28. The method of claim 25, wherein said preparation includes: placing said group in electrical contact with an interface unit, and wherein said allowing includes allowing logging during said placing.

29. The method of claim 25, wherein said preparation includes: removing a previously tested group of at least one device from electrical contact with an interface unit, and wherein said allowing includes allowing logging during said removing.

30. The method of claim 25, wherein said preparation includes: unloading a previously tested batch, and wherein said allowing includes allowing logging during said unloading.

31. The method of claim 25, wherein said preparation includes loading a batch which includes said group, and wherein said allowing includes allowing logging during said loading.

32. The method of claim 25, wherein said preparation includes indexing, and wherein said allowing includes allowing logging during said indexing.

33. The method of claim 25, wherein said group includes a single device.

34. The method of claim 25, wherein said group includes a plurality of devices which will be tested in parallel.

35. The method of claim 25, further comprising: receiving a disable indication, and wherein said allowing logging includes: after receiving said disable indication, not allowing logging of semiconductor test data relating to at least one test site during at least part of a time interval in which said group is being prepared for testing.

36. The method of claim 25, wherein there are at least two test site controllers for testing said prepared group, further comprising:
after testing has been completed for any devices in said prepared group associated with one of the at least two test site controllers, allowing logging of semiconductor test data relating to said test site controller while testing is continuing for at least one other device in said prepared group associated with another of said at least two test site controllers.

37. The method of claim 25, wherein said allowing includes:
after testing has completed on a group of at least one device, allowing preparation of another group for testing, regardless of whether data-logging is occurring or not;
allowing data-logging to occur while said other group is being prepared for testing; and once said other group is prepared for testing, proceeding to test said other group, regardless of whether data-logging is occurring or not.

38. A system for managing logging of semiconductor test data, comprising:
a tester operating system and test program server associated with a test site controller configured to test at least one device, said at least one device being tested in parallel with at least one other device;
a datalog generation tool configured to log data relating to semiconductor testing; and
a datalog manager configured to at least occasionally allow said datalog generation tool to log data relating to said test site controller after said at least one device has completed testing but testing is continuing at any of said at least one other device.

39. A method of managing logging of semiconductor test data, comprising:
testing devices in parallel at test sites associated with test site controllers; and
allowing logging of semiconductor test data relating to one of said test site controllers during at least part of a time gap between testing completion at all test sites associated with said one test site controller and testing completion at all test sites associated with said test site controllers.

40. A module for managing datalog, comprising:
at least one interface configured to at least receive an indication that testing has completed at all test sites associated with a test site controller; and
a datalog manager control engine configured to at least occasionally allow logging of data relating to said test site controller after said indication has been received while testing is continuing at at least one other test site associated with a different test site controller.

41. A computer program product comprising a computer useable medium having computer readable program code embodied therein for managing logging of semiconductor test data, the computer program product comprising:
computer readable program code for causing the computer to allow logging of semiconductor test data during at least part of a time interval in which a group of at least one device is being prepared for testing by handling equipment.

42. A computer program product comprising a computer useable medium having computer readable program code embodied therein for managing logging of semiconductor test data, the computer program product comprising:
computer readable program code for causing the computer to test devices in parallel at test sites associated with test site controllers; and
computer readable program code for causing the computer to allow logging of semiconductor test data relating to one of said test site controllers during at least part of a time gap between testing completion at all test sites associated with said one test site controller and testing completion at all test sites associated with said test site controllers.
